(19) United States
(12) Patent Application Publication
(10) Pub. No.: US 2023/0205815 A1
(43) Pub. Date: Jun. 29, 2023

(54) INFORMATION PROCESSING DEVICE, CONTROL METHOD AND STORAGE MEDIUM

(71) Applicant: NEC Corporation, Minato-ku, Tokyo (JP)

(72) Inventors: Haruna WATANABE, Tokyo (JP); Katsumi KIKUCHI, Tokyo (JP); Soma SHIRAISHI, Tokyo (JP); Yu NABETO, Tokyo (JP)

(73) Assignee: NEC Corporation, Minato-ku, Tokyo (JP)

(21) Appl. No.: 17/926,731

(22) PCT Filed: May 26, 2020
(86) PCT No.: PCT/JP2020/020772

§ 371 Date: Nov. 21, 2022

(51) Int. Cl. G06F 16/75; G06F 16/65

(52) U.S. Cl. CPC G06F 16/75; G06F 16/65

(57) ABSTRACT

The information processing device 1X mainly includes a pair determination means 15X and a relevance degree calculation unit 16X. The pair determination means 15X is configured to determine a pair of data at least one member of which is a first digest candidate that is a candidate of a digest, the data including at least one of video data or audio data. The relevance degree calculation means 16X is configured to calculate a degree of relevance indicating a degree of probability that the pair determined by the pair determination means 15X is included in the digest at a time.

### TECHNICAL FIELD

The present disclosure relates to an information processing device, a control method, and a recording medium for performing a process related to generating of a digest.

### BACKGROUND ART

There are technologies which generate a digest by editing video data that is raw material data. For example, Patent Literature 1 discloses a method for manufacturing the digest by confirming highlight scenes from a video stream of a sports event at a ground.

### PRIOR ART DOCUMENTS

### Patent Literature

Patent Literature 1: JP 2019-522948A

### SUMMARY

### Problem to be Solved by the Invention

When the degree of importance is calculated for raw material video data, and the digest is autonomously generated based on the degree of importance, as a result of combining scenes with low relevance, there was a possibility that the digest which is difficult to understand the story could be generated.

In view of the above-described issue, it is therefore an example object of the present disclosure to provide an information processing device, a control method, and a storage medium capable of generating information suitable for digest generation.

### Means For Solving the Problem

In one mode of the information processing device, there is provided an information processing device including: a pair determination means configured to determine a pair of data at least one member of which is a first digest candidate that is a candidate of a digest, the data including at least one of video data or audio data; and a relevance degree calculation means configured to calculate a degree of relevance indicating a degree of probability that the pair is included in the digest at a time.

In one mode of the control method, there is provided a control method executed by a computer, the control method including: determining a pair of data at least one member of which is a first digest candidate that is a candidate of a digest, the data including at least one of video data or audio data; and calculating a degree of relevance indicating a degree of probability that the pair is included in the digest at a time.

In one mode of the storage medium, there is provided a storage medium storing a program executed by a computer, the program causing the computer to function as: a pair determination means configured to determine a pair of data at least one member of which is a first digest candidate that is a candidate of a digest, the data including at least one of video data or audio data; and a relevance degree calculation means configured to calculate a degree of relevance indicating a degree of probability that the pair is included in the digest at a time.

### Effect of the Invention

An example advantage according to the present invention is to suitably generate information suitable for digest generation.

### BRIEF DESCRIPTION OF THE DRAWINGS

FIG. 1 illustrates a configuration of a digest candidate selection system according to a first example embodiment.

FIG. 2 illustrates a hardware configuration of an information processing device.

FIG. 3 illustrates an example of a functional block of the information processing device.

FIG. 4 is a diagram showing an outline of the first digest candidate selection process common to the first selection example and the second selection example.

FIG. 5 is a diagram showing an outline of the second digest candidate selection process according to the first selection example after the selection of the first digest candidate.

FIG. 6 is a diagram showing an outline of the second digest candidate selection process according to the second selection example after the selection of the first digest candidate.

FIG. 7 is a schematic configuration diagram of a learning system configured to generate relevance degree inference engine information.

FIG. 8 illustrates an example of a functional block configuration of a learning device.

FIG. 9 illustrates an example of a flowchart showing a procedure of the process performed by the information processing device in the first example embodiment.

FIG. 10 illustrates an example of a flowchart showing a procedure of the process performed by the learning device in the first example embodiment.

FIG. 11 is an example of a functional block diagram of the information processing device according to a second modification.

FIG. 12 illustrates an example of a flowchart showing a procedure of the process performed by the information processing device in the second modification.

FIG. 13 is a functional block diagram of the information processing device according to a second example embodiment.

FIG. 14 illustrates an example of a flowchart performed by the information processing device in the second example embodiment.

### EXAMPLE EMBODIMENTS

Hereinafter, an example embodiment of an information processing device, a control method, and a storage medium will be described with reference to the drawings.

### First Example Embodiment

(1) System Configuration

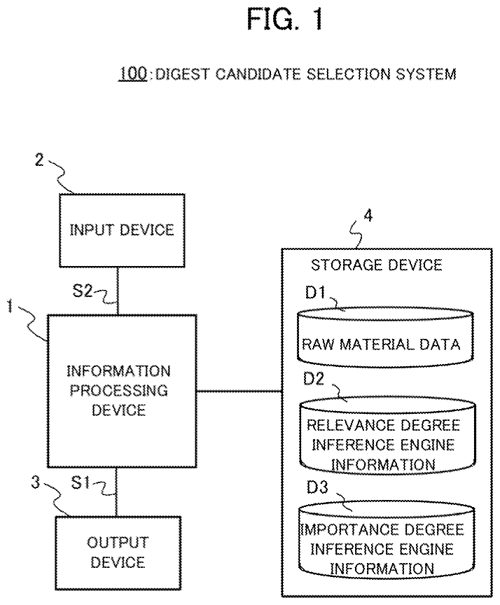

FIG. 1 shows the configuration of the digest candidate selection system 100 according to the first example embodiment. The digest candidate selection system 100 suitably selects video data as a candidate for the digest from raw material video data (also referred to as “raw material data”). The digest candidate selection system 100 mainly includes an information processing device 1, an input device 2, an output device 3, and a storage device 4.

The information processing device 1 performs data communication with the input device 2 and the output device 3 through a communication network or by wired or wireless direct communication. By referring to the relevance degree inference engine information D2 and the importance degree inference engine information D3 stored in the storage device 4, the information processing device 1 selects the video data to be a candidate for the digest from the raw material data D1 stored in the storage device 4. Then, the information processing device 1 generates an output signal “S1” relating to the above-described selection result, and supplies the generated output signal S1 to the output device.

The input device 2 is a user interface configured to accept a user input, and examples of the input device 2 include a button, a keyboard, a mouse, a touch panel, and a voice input device. The input device 2 supplies the input signal “S2” generated based on the user input to the information processing device 1. The output device 3 performs a predetermined display or sound output based on the output signal S1 supplied from the information processing device 1 and examples of the output device 3 include a display device such as a display and a projector, and a sound output device such as a speaker.

The storage device 4 is a memory that stores various kinds of information necessary for processing the information processing device 1. For example, the storage device 4 stores raw material data D1, relevance degree inference engine information D2, and importance degree inference engine information D3.

The raw material data D1 is video data to be edited in generating the digest. Hereafter, video data which corresponds to a section with a predetermined playback time length and which is extracted from the raw material data D1 is also referred to as “section data”. Each section data includes a time-series image which includes a predetermined number (one or more) of images. In the first example embodiment, the information processing device 1 selects pairs subject to calculation of the degree of importance and the degree of relevance from a plurality of section data obtained by dividing the raw material data D1 in units of section.

The relevance degree inference engine information D2 is the information relating to an inference engine (also referred to as “relevance degree inference engine”) configured to infer the degree of relevance between a pair (also referred to as “inference target pair Ptag”) of the section data. The degree of relevance is an index that indicates the relevance in terms of whether or not the members of the inference target pair Ptag are included in the digest at the same time. In other words, the degree of relevance is an index that indicates the degree of probability (or validity) that the members of the inference target pair Ptag are included in the digest at the same time. The relevance degree inference engine is learned in advance so as to infer, when a predetermined number (one or more) of images corresponding to a pair of section data is inputted thereto, the degree of relevance therebetween. The relevance degree inference engine information D2 includes the parameters of the learned relevance degree inference engine.

The importance degree inference engine information D3 is the information relating to an inference engine (also called “importance degree inference engine”) configured to infer the degree of importance for the section data. The above importance is an index that serves as a criterion for determining whether a section in the raw material data D1 corresponding to the inputted video data is an important section or a non-important section in the generation of the digest. The importance degree inference engine is learned in advance so as to infer, when a predetermined number (one or more) of images constituting the section data is inputted thereto, the degree of importance for the target section. The importance degree inference engine information D3 includes the parameters of the learned importance degree inference engine.

The learning models of the relevance degree inference engine and the importance degree inference engine may be learning models based on any machine learning, such as a neural network and a support vector machine, respectively. For example, if the models of the relevance degree inference engine and importance degree inference engine described above are based on neural network such as convolutional neural network, then the relevance degree inference engine information D2 and importance degree inference engine information D3 include various parameters relating to layer structure, neuron structure of each layer, number of filters and filter sizes in each layer, and weights for each element of each filter.

The storage device 4 may be an external storage device such as a hard disk connected to or built in to the information processing device 1, or may be a storage medium such as a flash memory. The storage device 4 may be one or more server devices configured to perform data communication with the information processing device 1. The storage device 4 may include a plurality of devices. In this case, the storage device 4 may store the raw material data D1, the relevance degree inference engine information D2, and the importance degree inference engine information D3 in a distributed manner.

The configuration of the digest candidate selection system 100 described above is an example, and various changes may be applied to the configuration. For example, the input device 2 and the output device 3 may be configured integrally. In this case, the input device 2 and the output device 3 may be configured as a tablet type terminal integral with the information processing device 1. Further, the information processing device 1 may be configured by a plurality of devices. In this case, a plurality of devices constituting the information processing device 1, the transmission and reception of information necessary for executing the pre-allocated processing, performed between the plurality of devices.

(2) Hardware Configuration of Information Processing Device

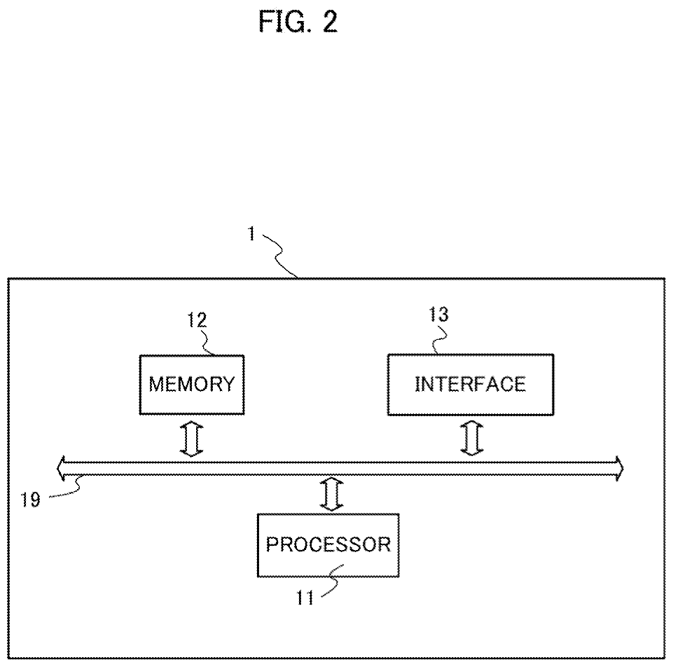

FIG. 2 illustrates the hardware configuration of the information processing device 1. The information processing device 1 includes a processor 11, a memory 12, and an interface 13 as hardware. The processor 11, the memory 12, and the interface 13 are connected via a data bus 19.

The processor 11 executes a predetermined process by executing a program stored in the memory 12. The processor 11 is one or more processors such as a CPU (Central Processing Unit), GPU (Graphics Processing Unit), and a quantum processor.

The memory 12 is configured by various volatile and non-volatile memories such as RAM (Random Access Memory), ROM (Read Only Memory), and the like. In addition, a program executed by the information processing device 1 is stored in the memory 12. The memory 12 is used as a work memory and temporarily stores information acquired from the storage device 4. The memory 12 may function as a storage device 4. Similarly, the storage device 4 may function as a memory 12 of the information processing device 1. The program executed by the information processing device 1 may be stored in a storage medium other than the memory 12.

The interface 13 is an interface for electrically connecting the information processing device 1 and other devices. For example, the interface for connecting the information processing device 1 and other devices may be a communication interface such as a network adapter for performing transmission and reception of data to and from other devices by wired or wireless communication under the control of the processor 11. In another example, the information processing device 1 and other devices may be connected by a cable or the like. In this instance, the interface 13 includes a hardware interface compliant with USB (Universal Serial Bus), SATA (Serial AT Attachment), and the like for exchanging data with other devices.

The hardware configuration of the information processing device 1 is not limited to the configuration shown in FIG. 2. For example, the information processing device 1 may include at least one of the input device 2 or the output device 3.

(3) Functional Block

Next, a description will be given of a functional block of the information processing device 1. Here, the information processing device 1 selects temporary digest candidates (also referred to as “first digest candidates”) from a plurality of section data of the raw material data D1, and, based on the first digest candidates, selects digest candidates (also referred to as “second digest candidates”) to be finally outputted.

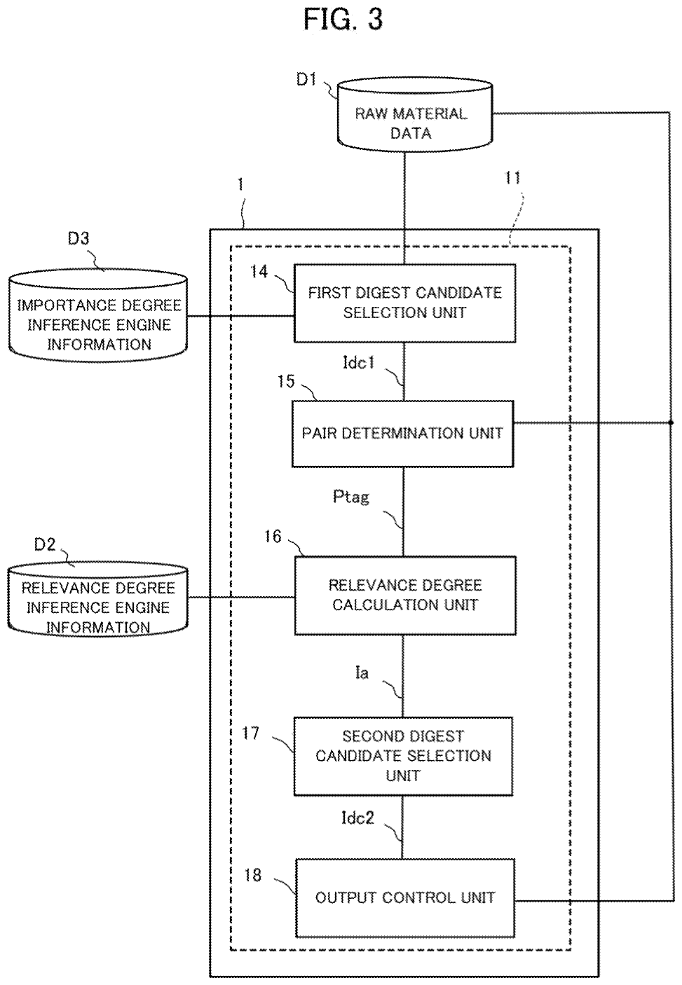

FIG. 3 is an example of a functional block of the processor 11 of the information processing device 1. The processor 11 of the information processing device 1 functionally includes a first digest candidate selection unit 14, a pair determination unit 15, a relevance degree calculation unit 16, a second digest candidate selection unit 17, and an output control unit 18. In FIG. 3, the blocks to exchange data are connected to each other by solid line, however, the combinations of blocks to exchange data are not limited to FIG. 3. The same applies to other functional block diagrams to be described later.

The first digest candidate selection unit 14 calculates the degree of importance for each section data included in the raw material data D1, and selects the first digest candidates from a plurality of section data included in the raw material data D1 based on the calculated degree of importance. Here, each section data is data obtained by dividing the raw material data D1 in section units, and each section data has a predetermined time length and includes a predetermined number (one or more) of images. Then, for example, the first digest candidate selection unit 14 configures the importance degree inference engine by referring to the importance degree inference engine information D3, and sequentially inputs each section data extracted from the raw material data D1 to the importance degree inference engine to acquire the degree of importance corresponding to the each section data. Then, the first digest candidate selection unit 14 selects the section data whose degree of importance is equal to or higher than a predetermined threshold as the first digest candidate. Hereafter, section data that is not a first digest candidate are also referred to as “non-first digest candidate”. The first digest candidate selection unit 14 supplies information (also referred to as “first digest candidate information Idc1”) relating to the first digest candidates to the pair determination unit 15.

The pair determination unit 15 determines a plurality of inference target pairs Ptag each of which is a combination of two pieces of section data extracted from the raw material data D1 on the basis of the first digest candidate information Idc1 generated by the first digest candidate selection unit 14. In this case, in the first example, the pair determination unit 15 determines the inference target pairs Ptag each of which is a combination of two pieces of section data randomly selected from the first digest candidates. In the second example, the pair determination unit 15 determines inference target pairs Ptag each of which is a combination of a piece of section data randomly selected from the first digest candidates and a piece of section data randomly selected from the non-first digest candidates. Then, the pair determination unit 15 supplies the determined inference target pairs Ptag to the relevance degree calculation unit 16.

The pair determination unit 15 may limit the inference target pairs Ptag by the method described below in order to reduce the entire processing load of the information processing device 1. For example, the pair determination unit 15 may determine an inference target pair Ptag to be two pieces of section data between which the difference of the corresponding playback time is within a predetermined time difference. In another example, the pair determination unit 15 may determine the inference target pairs Ptag selected from only a plurality of section data which are extracted from the raw material data D1 at predetermined time intervals. In yet another example, the pair determination unit 15 may apply an arbitrary clustering method to a plurality of section data to perform the classification, and determine the inference target pairs Ptag selected from only a plurality of section data belonging to a predetermined class.

The relevance degree calculation unit 16 calculates the degree of relevance for each of the inference target pairs Ptag supplied from the pair determination unit 15. In this case, the relevance degree calculation unit 16 configures the relevance degree inference engine by referring to the relevance degree inference engine information D2, and sequentially inputs the inference target pair Ptag acquired from the pair determination unit 15 to the relevance degree inference engine, thereby calculating the degree relevance degree with respect to each of the inference target pairs Ptag. The relevance degree calculation unit 16 supplies information (also referred to as “relevance degree information Ia”) indicating the calculated degree of relevance to the second digest candidate selection unit 17.

The second digest candidate selection unit 17 selects the second digest candidates based on the relevance degree information Ia supplied from the relevance degree calculation unit 16. The second digest candidate selection unit 17 supplies information (also referred to as “second digest candidate information Idc2”) relating to the selected second digest candidates to the output control unit 18. Here, the second digest candidate information Idc2 may include section data itself serving as a second digest candidate, or may include time information (information indicating the playback time in the raw material data D1) indicative of the playback time of the section data serving as a second digest candidate.

Here, when the inference target pairs Ptag are selected from the first digest candidates, the second digest candidate selection unit 17 selects second digest candidates that are first digest candidates belonging to inference target pairs Ptag whose degree of relevance is equal to or greater than a predetermined threshold. Thus, the second digest candidate selection unit 17 can suitably determine the second digest candidates which are narrowed down based on the degree of relevance from the first digest candidates. On the other hand, when an inference target pair Ptag is a combination of a first digest candidate and a non-first digest candidate, the second digest candidate selection unit 17 adds non-first digest candidates of the inference target pairs Ptag whose degree of relevance is equal to or higher than a threshold to second digest candidates in addition to the first digest candidates. In this case, the second digest candidate selection unit 17 can suitably classify a non-first digest candidate having a high degree of relevance with a first digest candidate into as a second digest candidate.

The output control unit 18 performs the output control based on the second digest candidate information Idc2 supplied from the second digest candidate selection unit 17. In the first example, the output control unit 18 generates an output signal S1 relating to the second digest candidate information Idc2, and transmits the generated output signal S1 to the output device 3 via the interface 13. In this case, for example, by transmitting the output signal S1 for playing back the section data corresponding to the second digest candidates to the output device 3, the output control unit 18 plays back the section data corresponding to the second digest candidates on the output device 3. Accordingly, the output control unit 18 can cause the viewer to confirm whether or not the second digest candidates are suitable as a digest. In the second example, the output control unit 18 stores the second digest candidate information Idc2 in the storage device 4 through the interface 13. In the third example, the output control unit 18 transmits the second digest candidate information Idc2 to an external device configured to perform the generation process of the final digest via the interface 13.

Each component of the first digest candidate selection unit 14, the pair determination unit 15, the relevance degree calculation unit 16, the second digest candidate selection unit 17, and the output control unit 18 described in FIG. 3 can be realized by the processor 11 executing a program, for example. In addition, the necessary program may be recorded in any non-volatile storage medium and installed as necessary to realize the respective components. In addition, at least a part of these components is not limited to being realized by a software program and may be realized by any combination of hardware, firmware, and software. At least some of these components may also be implemented using user-programmable integrated circuitry, such as FPGA (Field-Programmable Gate Array) and microcontrollers. In this case, the integrated circuit may be used to realize a program for configuring each of the above-described components.

In this way, each component may be implemented by any type of a controller which includes a variety of hardware other than a processor. The above is true for other example embodiments to be described later.

(4) Specific Examples

Next, specific examples on the selection of the second digest candidates will be described. Hereafter, a first selection example for selecting the second digest candidates from the first digest candidates, and a second selection example for selecting non-first digest candidates with high relevance with first digest candidates as the second digest candidates in addition to the first digest candidates will be described.

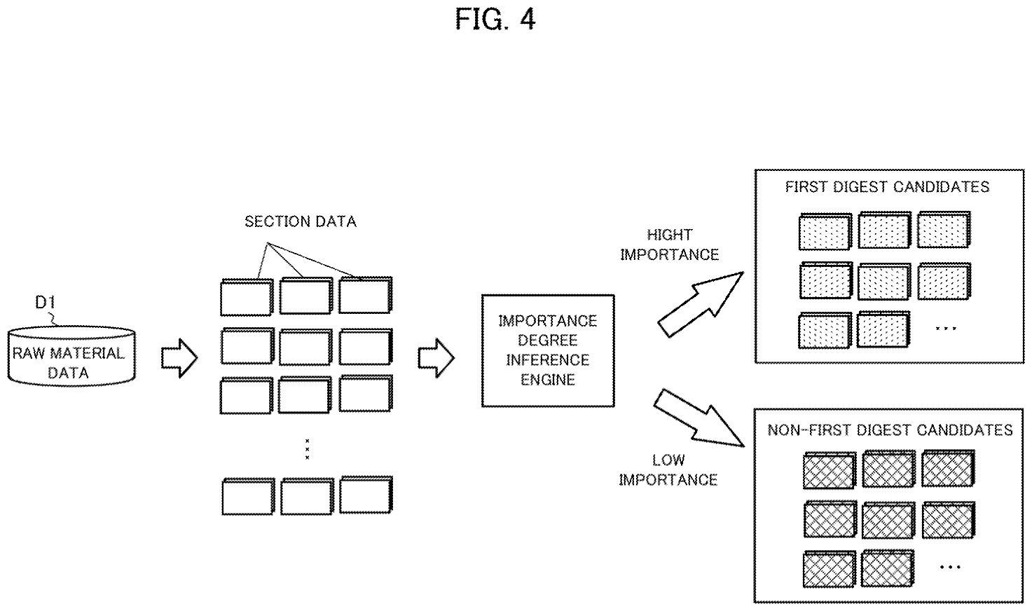

FIG. 4 is a diagram showing an outline of the selection process of the first digest candidates common to the first selection example and the second selection example.

First, the first digest candidate selection unit 14 extracts a plurality of section data (plural pieces of section data) each having a unit time length from the raw material data D1, and sequentially inputs each extracted piece of section data to the importance degree inference engine configured by referring to the importance degree inference engine information D3. Thereby, the first digest candidate selection unit 14 calculates the degree of importance for each section data (each piece of section data). Then, the first digest candidate selection unit 14 uses each section data whose degree of importance is equal to or higher than a predetermined threshold as a first digest candidate, and uses each section data whose degree of importance is less than the predetermined threshold as a non-first digest candidate.

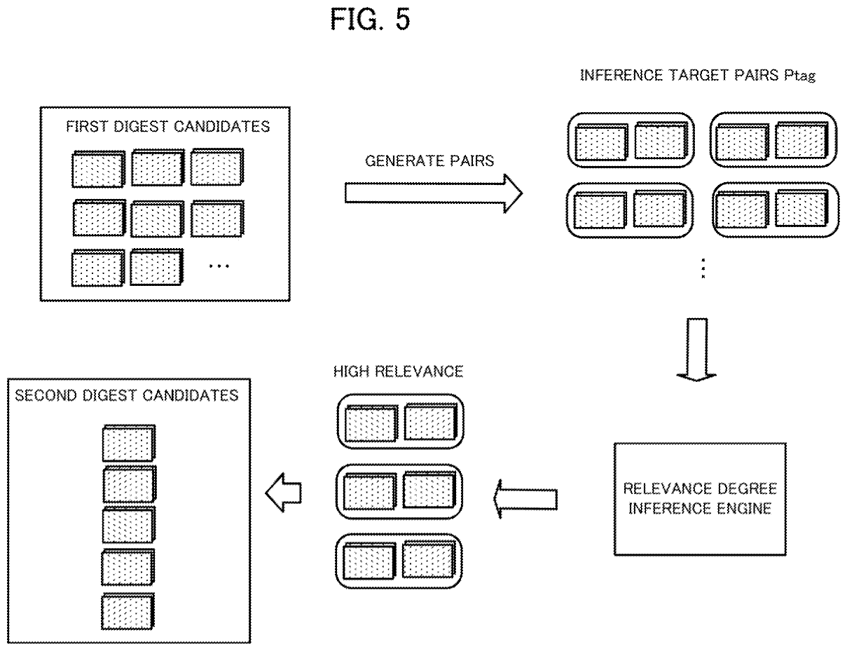

FIG. 5 is a diagram showing an outline of the selection process of the second digest candidates according to the first selection example after the selection of the first digest candidates.

In the first selection example, the pair determination unit 15 determines inference target pairs Ptag each of which is a combination of two pieces of section data serving as first digest candidates. In this case, the pair determination unit 15 may use all possible pairs selected from all first digest candidates as the inference target pairs Ptag, or may use a part of all possible pairs selected from all first digest candidates as the inference target pairs Ptag.

Then, the relevance degree calculation unit 16 inputs each of the inference target pairs Ptag determined by the pair determination unit 15 to the relevance degree inference engine configured by referring to the relevance degree inference engine information D2. Accordingly, the relevance degree calculation unit 16 calculates the degree of relevance for each of the inference target pairs Ptag. The second digest candidate selection unit 17 selects a plurality of section data included in the inference target pairs Ptag whose calculated degree of relevance is equal to or higher than a predetermined threshold as second digest candidates. Thereby, the second digest candidate selection unit 17 can suitably narrow down the second digest candidates to such section data serves as first digest candidates with a high degree of relevance.

Here, a supplemental explanation will be given of a method for selecting inference target pairs Ptag from possible pairs of first digest candidates. In the first determination method, the pair determination unit 15 selects, as the inference target pairs Ptag, pairs of first digest candidates (that are section data) between each of which the playback time is within a predetermined time difference. In the second determination method, the pair determination unit 15 determines the inference target pairs Ptag based on the first digest candidates corresponding to the section data selected from the raw material data D1 at fixed time (e.g., 2 seconds) intervals. In the third selection method, the pair determination unit 15 firstly performs clustering of a plurality of section data serving as the first digest candidates, and determines the inference target pairs Ptag based on a plurality of section data included in a particular class. In this case, for example, the pair determination unit 15 performs a predetermined feature extraction process for each section data, and makes a determination (i.e., class identification) of the class to which the each section data belongs among preset classes based on the extracted feature. In another example, the pair determination unit 15 may perform the clustering based on a user input via the input device 2.

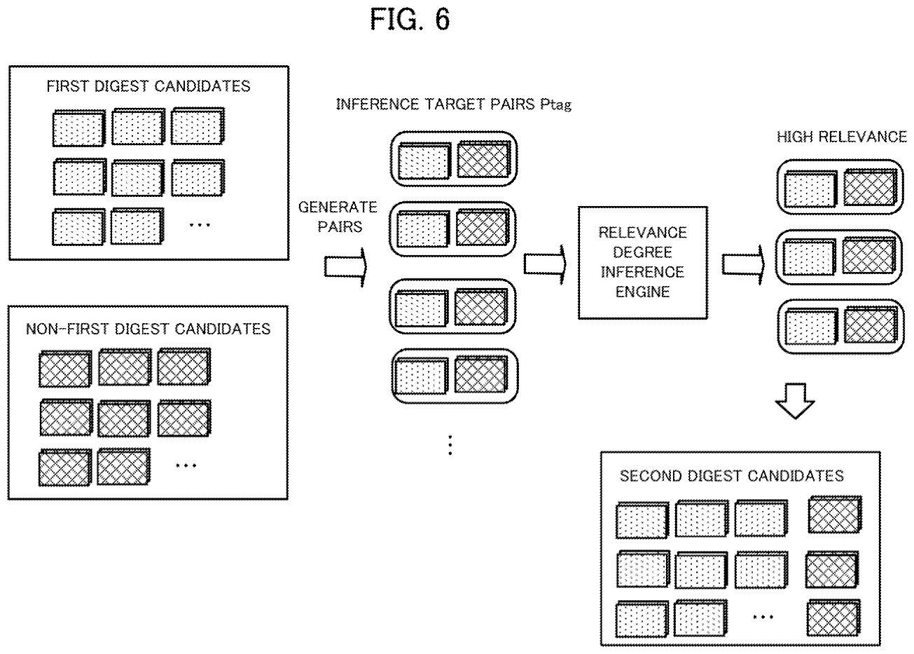

FIG. 6 is a diagram showing an outline of the selection process of the second digest candidates according to the second selection example after the selection of the first digest candidates.

In the second selection example, the pair determination unit 15 determines the inference target pairs Ptag each of which is a combination of a first digest candidate selected from a plurality of first digest candidates and a non-first digest candidate selected from a plurality of non-first digest candidates. In this case, the pair determination unit 15 may select all possible combinations of a first digest candidate and a non-first digest candidate as the inference target pairs Ptag, or may select a part of the all possible combinations as the inference target pairs Ptag.

Then, the relevance degree calculation unit 16 inputs each of the inference target pairs Ptag determined by the pair determination unit 15 to the relevance degree inference engine configured by referring to the relevance degree inference engine information D2. Accordingly, the relevance degree calculation unit 16 calculates the degree of relevance of each of the inference target pairs Ptag. Then, the second digest candidate selection unit 17 selects, as the second digest candidates, not only all first digest candidates but also non-first digest candidates included in such inference target pairs Ptag whose calculated degree of relevance is equal to or higher than a predetermined threshold. In this case, the second digest candidate selection unit 17 can incorporate the non-first digest candidates having a high degree of relevance with the first digest candidates into the second digest candidates. This makes it possible to suitably incorporate scenes around important scenes necessary for understanding the story into digest candidates.

Here, a supplementary explanation will be given on how to select, as inference target pairs Ptag, a part of combinations of a first digest candidate and a non-first digest candidate. In the first selection method, the pair determination unit 15 selects, as the inference target pairs Ptag, pairs of a first digest candidate and a non-first digest candidate between which the playback time is within a predetermined time difference. In the second selection method, the pair determination unit 15 selects the inference target pairs Ptag based on the first digest candidates and the non-first digest candidates corresponding to the section data selected from the raw material data D1 at fixed time (e.g., 2 seconds) intervals. In the third selection method, the pair determination unit 15 performs clustering of the first digest candidates and the non-first digest candidates, and selects the inference target pairs Ptag from the first digest candidates and the non-first digest candidates classified in a particular class.

(5) Learning of Relevance Degree Inference Engine

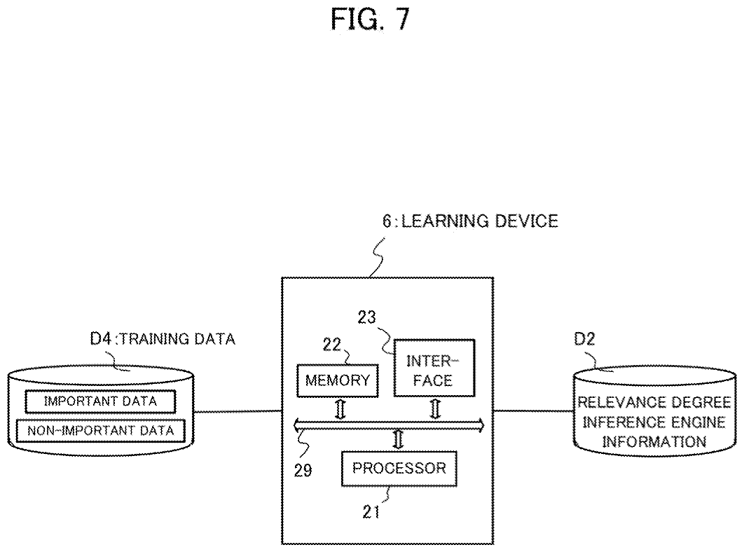

Next, the generation of the relevance degree inference engine information D2 by learning the relevance degree inference engine is explained. FIG. 7 is a schematic configuration diagram of a learning system configured to generate the relevance degree inference engine information D2. The learning system includes a learning device 6 configured to refer to training data D4.

The learning device 6 has the same configuration as that of the information processing device 1 illustrated in FIG. 2, for example, and mainly includes a processor 21, a memory 22, and an interface 23. The learning device 6 may be the information processing device 1, or may be any device other than the information processing device 1.

The training data D4 includes training raw material data which is raw material data for training, and labels which indicates whether the training raw material data is important or not for every unit time interval. The digest (digest for training) is generated beforehand by manual work from the training raw material data, and each section data of the training raw material used as a part of the digest is labeled with an important label, and each section data which does not used as a part of the digest is labeled with a non-important label. Hereafter, each section data (i.e., components of the digest for training) of the training material data labeled with the important label is referred to as “important data”, and each section data of the training material data labeled with the non-important label is referred to as “non-important data”.

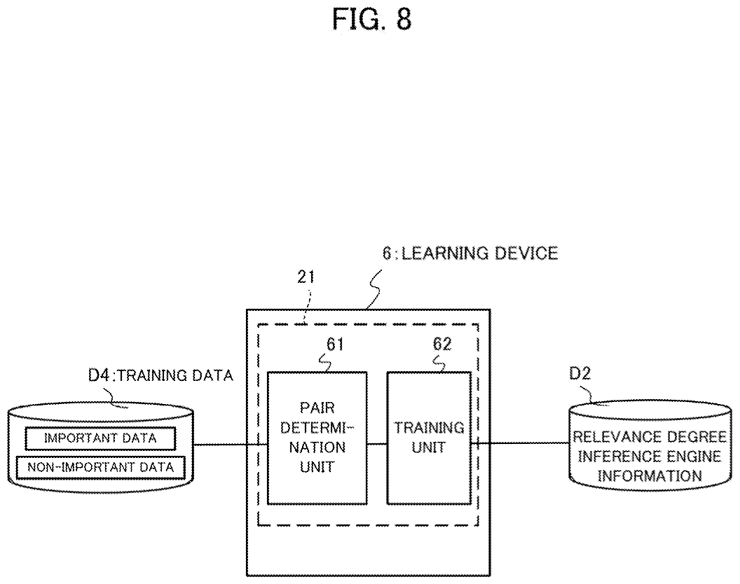

FIG. 8 shows an example of a functional block configuration of the learning device 6. The learning device 6 functionally mainly includes a pair determination unit 61 and a training unit 62. The pair determination unit 61 and the training unit 62 are realized by, for example, the processor 21.

The pair determination unit 61 refers to the training data D4, and determines inference target pairs Ptag for training selected from a plurality of section data of the training raw material data, and generates correct answer labels for these pairs. A specific example of the process by the pair determination unit 61 will be described later.

The training unit 62 performs learning (training) of the relevance degree inference engine based on combinations of the inference target pair Ptag for training determined by the pair determination unit 61 and the correct answer label. In this case, the learning device 6 determines the parameters of the relevance degree inference engine so that the error (loss) between the output from the relevance degree inference engine when the inference target pair Ptag for training is inputted to the relevance degree inference engine and the correct answer label corresponding to the inputted inference target pair Ptag for training is minimized. The algorithm for determining the parameters described above to minimize loss may be any learning algorithm used in machine learning, such as a gradient descent method and an error back-propagation method. The training unit 62 may further perform the learning (training) of the importance degree inference engine by referring to the training data D4 to generate the importance degree inference engine information D3.

Next, specific examples (the first training example and the second training example) of the process executed by the pair determination unit 61 will be described.

In the first training example, the pair determination unit 61 determines all possible combinations of any two selected from a plurality of important data and a plurality of non-important data included in the training material data as training inference target pairs Ptag. Then, the pair determination unit 61 associates a correct answer label indicative of a positive example with each inference target pair Ptag that is a pair of two pieces of important data and associates a correct answer label indicative of a negative example with each inference target pair Ptag that belongs to the other pairs. The term “other pairs” refers to a pair of two pieces of non-important data and a pair of important data and non-important data. After that, for example, in the case of a correct answer label indicative of a negative example, the training unit 62 sets the correct answer of the degree of relevance to the lowest value, and in the case of a correct answer label indicative of a positive example, the training unit 62 sets the correct answer of the degree of relevance to the maximum value, and then trains the relevance degree inference engine.

According to the first learning example, the learning device 6 can suitably learn the relevance degree inference engine so that the higher the probability that a pair of inputted two pieces of section data is included in the digest at the same time is, the higher the degree of relevance to be outputted becomes.

In the second learning example, the pair determination unit 61 determines the inference target pair Ptag for training to be any two pieces of section data (including the important data and the non-important data) included in the training raw material data. Then, the training unit 62 determines a correct answer label for each inference target pair Ptag for training to indicate a value in accordance with the difference in the playback time between the two pieces of section data of the target inference target pair Ptag. Examples of the “value in accordance with the difference in the playback time” include a value normalized according to the value range of the degree of relevance so that the closer the playback time of the two pieces of section data is, the closer number to 1 (e.g., the maximum value of the degree of relevance) the value becomes, and, the farther the playback time of the two pieces of section data is, the closer number to 0 (e.g., the minimum value of the degree of relevance) the value becomes.

According to the second learning example, the learning device 6 can suitably learn the relevance degree inference engine so that the degree of relevance to be outputted increases with increasing connection as a story between a pair of the inputted section data.

It is noted that the information processing device 1 can suitably use non-first digest candidates, which is temporally close to the first digest candidates, as second digest candidates by applying the relevance degree inference engine learned in the second learning example to the second selection example shown in FIG. 7, for example. Thus, the information processing device 1 suitably selects the peripheral scene of the important scene as the second digest candidate, and can suitably support the generation of the digest which is easy to understand the story.

(6) Process Flow

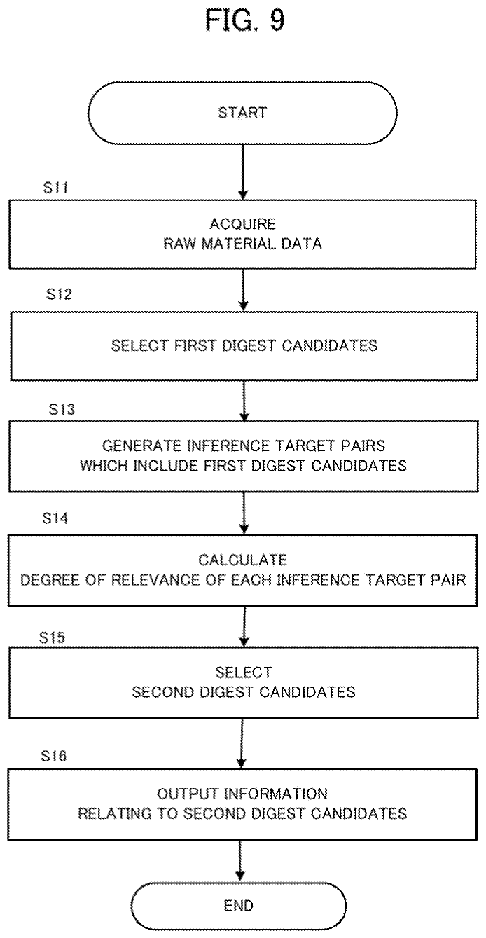

FIG. 9 is an example of a flowchart showing the procedure of the process executed by the information processing device 1 in the first example embodiment. The information processing device 1 executes the process of the flowchart shown in FIG. 9, for example, when a user input instructing the start of the process is detected.

First, the first digest candidate selection unit 14 of the information processing device 1 acquires the raw material data D1 from the storage device 4 via the interface 13 (step S11). When the raw material data D1 corresponding to a plurality of contents is stored in the storage device 4, the first digest candidate selection unit 14 acquires the raw material data D1 corresponding to the content specified by the user input or the like.

Next, the first digest candidate selection unit 14 selects first digest candidates from a plurality of section data included in the raw material data (step S12). In this case, the first digest candidate selection unit 14 calculates the degree of importance of each section data by inputting the each section data to the importance degree inference engine configured by referring to the importance degree inference engine information D3, and selects plural pieces of section data as first digest candidates based on the calculated degree of importance.

Next, the pair determination unit 15 generates inference target pairs Ptag including the first digest candidates (step S13). In this case, the pair determination unit 15 may generate an inference target pair Ptag of any two selected from the first digest candidates according to the above-described first selection example, or may generate an inference target pair Ptag of a first digest candidate and a non-first digest candidate according to the second selection example.

Next, the relevance degree calculation unit 16 calculates the degree of relevance of each of the inference target pairs Ptag generated at step S13 (step S14). In this case, the relevance degree calculation unit 16 sequentially inputs each inference target pair Ptag to the relevance degree inference engine configured by referring to the relevance degree inference engine information D2, thereby calculating the degree of relevance of each of the inference target pairs Ptag.

Next, the second digest candidate selection unit 17 performs selection of the second digest candidates (step S15). In this case, for example, in accordance with the above-described first selection example, the second digest candidate selection unit 17 selects, as the second digest candidates, the first digest candidates serving as the inference target pairs Ptag having the degree of relevance higher than a threshold. In another example, in accordance with the second selection example, the second digest candidate selection unit 17 selects non-first digest candidates each having the degree of relevance higher than a threshold with any of the first digest candidates as the second digest candidates together with the first digest candidates.

Next, the output control unit 18 outputs information on the second digest candidates (step S16). In this case, as described above, the output control unit 18 may supply information on the second digest candidates to an external device such as a storage device 4, or may output the information by the output device 3.

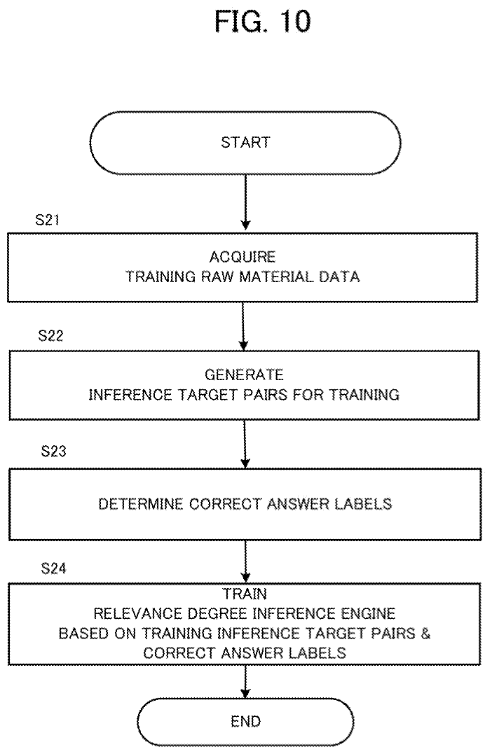

FIG. 10 is an example of a flowchart illustrating a procedure of the process performed by the learning device 6 in the first example embodiment. The learning device 6 executes process of the flowchart shown in FIG. 10, for example, when a user input instructing the start of processing is detected.

First, the pair determination unit 61 of the learning device 6 acquires the training raw material data from the training data D4 (step S21). When the training data D4 includes the training raw material data corresponding to a plurality of contents, the pair determination unit 61 acquires the training raw material data corresponding to the content specified by the user input or the like.

Next, the pair determination unit 61 generates the inference target pairs Ptag for training (step S22). In this case, the pair determination unit 61 generates the inference target pair Ptag for training selected from a plurality of section data included in the training raw material data, for example, in accordance with either the above-described first learning example or the second learning example.

Furthermore, the pair determination unit 61 determines the correct answer label for each inference target pair Ptag for training generated at step S22 (step S23). In this case, in accordance with the first learning example, the pair determination unit 61 may determine the correct answer label based on whether or not the each inference target pair Ptag for training is a pair of two pieces of important data. Otherwise, in accordance with the second learning example, it may determine the correct answer label to be a value corresponding to the difference in the playback time between two pieces of section data serving as the each inference target pair Ptag for training.

Then, the training unit 62 trains (learns) the relevance degree inference engine based on the training inference target pairs Ptag and the correct answer labels (step S24). Then, the learning device 6 generates the relevance degree inference engine information D2 that is parameters of the degree-of-relevance degree inference engine obtained by the learning. The generated relevance degree inference engine information D2 may be immediately stored in the storage device 4 through data communication between the storage device 4 and the learning device 6, or may be stored in the storage device 4 via a removable storage medium.

(7) Modifications

Next, a description will be given of each modification suitable for the above example embodiment. The following modifications may be applied to the example embodiments described above in arbitrary combination.

### First Modification

Instead of combining two pieces of section data extracted from single raw material data as an inference target pair Ptag, the pair determination unit 15 may combine two pieces of section data respectively extracted from different raw material data as an inference target pair Ptag.

For example, in this case, the first digest candidate selection unit 14 selects the first digest candidates from second raw material data different from the raw material data D1. In this case, the raw material data D1 and the second raw material data, for example, may be data taken by different cameras in a common time slot at a common location (e.g., sports venue). The second raw material data may be associated with labels for identifying the important section and the non-important section. In this case, the first digest candidate selection unit 14 selects, as the first digest candidates, a plurality of section data labeled as the important section.

Then, the pair determination unit 15 determines a pair of a first digest candidate extracted from the second raw material data and a piece of section data extracted from the raw material data D1 as an inference target pair Ptag. In this case, for example, the second digest candidate selection unit 17 selects, as second digest candidates, members of the inference target pairs Ptag having the degree of relevance equal to or higher than a predetermined value, wherein the members of the inference target pair Ptag are the first digest candidates extracted from the second raw material data and the section data of the raw material data D1. According to this mode, the information processing device 1 can suitably select digest candidates from a plurality of raw material data.

### Second Modification

The information processing device 1 may calculate and output the degree of relevance with respect to the inference target pair Ptag specified by the user input.

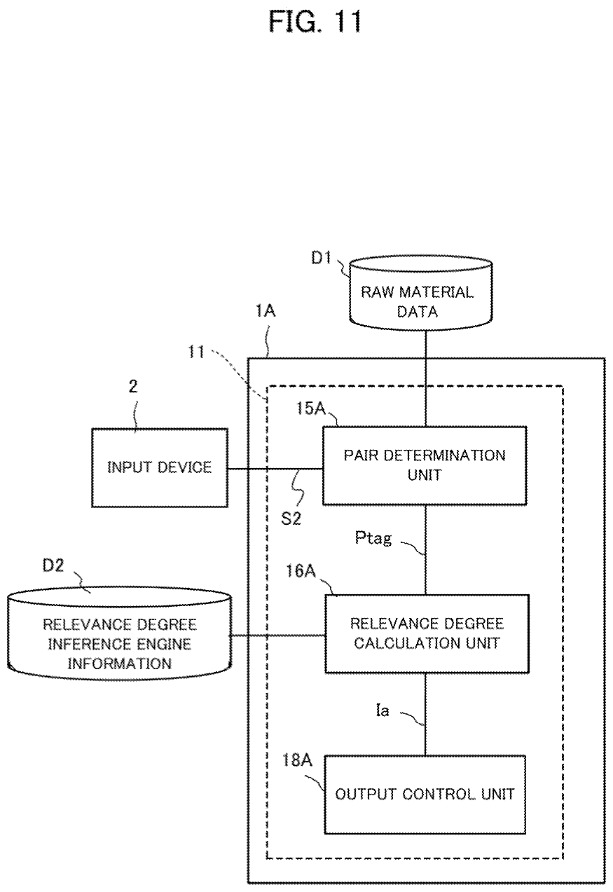

FIG. 11 is an example of a functional block diagram of an information processing device 1A according to the second modification. The processor 11 of the information processing device 1A includes a pair determination unit 15A, a relevance degree calculation unit 16A, and an output control unit 18A. Hereinafter, the same components as the components used in the example embodiment described above are appropriately denoted by the same reference numerals as in the example embodiment described above, and description thereof will be omitted.

The pair determination unit 15A determines an inference target pair Ptag based on the input signal S2 received from the input device 2 via the interface 13. For example, the pair determination unit 15A determines two pieces of section data included in the raw material data D1 specified based on the input signal S2 as an inference target pair Ptag.

In this case, for example, a piece of section data to be a digest candidate is specified as a piece of section data of an inference target pair Ptag by the user of the information processing device 1A, and a piece of section data subject to judgement of the suitability as a digest candidate is specified as the other piece of section data of the inference target pair Ptag. The pair determination unit 15 may accept an input specifying respective pieces of section data to be the inference target pair Ptag from the different raw material data, and then determine the respective section data as the inference target pair Ptag. Further, the pair determination unit 15A may determine a plurality of inference target pairs Ptag based on the input signal S2.

Then, the relevance degree calculation unit 16A calculates the degree of relevance of each inference target pair Ptag determined by the pair determination unit 15A based on the relevance degree inference engine configured by referring to the relevance degree inference engine information D2, and supplies the relevance degree information Ia relating to the calculated degree of relevance to the output control unit 18A. Then, the output control unit 18A performs an output based on the relevance degree information Ia. In this case, for example, the output control unit 18A supplies the output signal S1 for displaying the degree of relevance of the inference target pair Ptag to the output device 3.

In a case where there are a plurality of inference target pairs Ptag, the output control unit 18A may output only the information relating to the degree of relevance of the inference target pair(s) Ptag corresponding to top predetermined number of the degree of relevance or may output only the information relating to the degree of relevance of the inference target pair(s) Ptag having the degree of relevance equal to or greater than a predetermined threshold. The predetermined number described above may be set to any number (one or more).

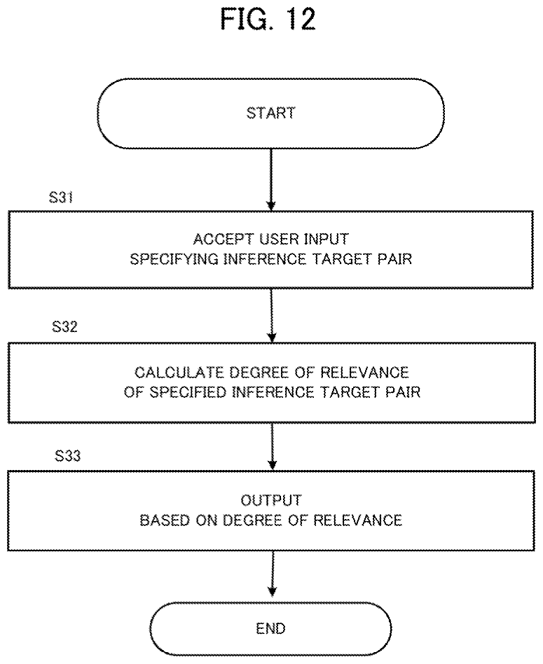

FIG. 12 is an example of a flowchart executed by the information processing device 1A in the second modification. First, the pair determination unit 15A of the information processing device 1A accepts a user input specifying one or more inference target pairs Ptag (step S31). In this case, the pair determination unit 15A may, for example, display a playback screen image of the raw material data D1 including a seek bar or the like, and lets the user specify the section data corresponding to any playback time as a member of the inference target pairs Ptag. Next, the relevance degree calculation unit 16A calculates the degree of relevance of each inference target pair Ptag specified at step S31 (step S32). Then, the output control unit 18A performs an output based on the degree of relevance calculated at step S32 (step S33).

Accordingly, the information processing device 1A according to the second modification can suitably calculate and output the degree of relevance with respect to the inference target pair Ptag specified by the user input.

### Third Modification

When audio data is included in addition to video data in the raw material data D1, the relevance degree calculation unit 16 may perform the calculation of the degree of relevance using the audio data.

In this case, in the first example, by referring to the relevance degree inference engine information D2, the relevance degree calculation unit 16 calculates the degree of relevance based on the video data and the audio data of two pieces of section data that are members of the inference target pair Ptag. In this case, the parameters of the relevance degree inference engine previously learned to output, when a pair of the section data including the image data and the audio data is inputted thereto, the degree of relevance of the pair is stored in the storage device 4 in advance as the relevance degree inference engine information D2. It is noted that the feature values of the audio data instead of the audio data itself may be inputted to the relevance degree inference engine. In this case, after a predetermined feature extraction process or the like is performed for the audio data, the extracted feature values are inputted to the relevance degree inference engine. Similarly, when calculating the degree of importance of each section data of the raw material data D1, the first digest candidate selection unit 14 may calculate the degree of importance of each section data using the audio data in addition to the video data.

In the second example, by referring to the relevance degree inference engine information D2, the relevance degree calculation unit 16 may calculate the degree of relevance based only on the audio data included in the two pieces of section data that are members of the inference target pair Ptag. In this case, the parameters of the relevance inference engine previously learned to output, when a pair of audio data is inputted thereto, the degree of relevance of the pair is stored in the storage device 4 in advance as the relevance degree inference engine information D2.

Accordingly, the information processing device 1 can suitably calculate the degree of relevance of the inference target pair Ptag using at least one of the video data or the audio data.

### Fourth Modification

In the functional block shown in FIG. 3, the information processing device 1 may not include at least one of the first digest candidate selection unit 14 or the second digest candidate selection unit 17.

For example, when labels for identifying the important sections and the non-important sections are previously associated with the raw material data D1, the pair determination unit 15 may determine the inference target pairs Ptag by using a plurality of section data corresponding to the important sections as the first digest candidates. In another example, the output control unit 18 may perform a predetermined output based on the relevance degree information Ia outputted by the relevance degree calculation unit 16. In this case, the output control unit 18A may output the information relating to the inference target pair(s) Ptag corresponding to top predetermined number of the degree of relevance, or may output only the information relating to the inference target pair(s) Ptag having the degree of relevance equal to or larger than a predetermined threshold. The predetermined number described above may be set to any number (one or more). The above-described “information relating to the inference target pair Ptag(s)” may be the section data itself of the inference target pair(s) Ptag, or may be the time information (information indicating the playback time in the raw material data D1) on the section data of the inference target pair(s) Ptag.

### Second Example Embodiment

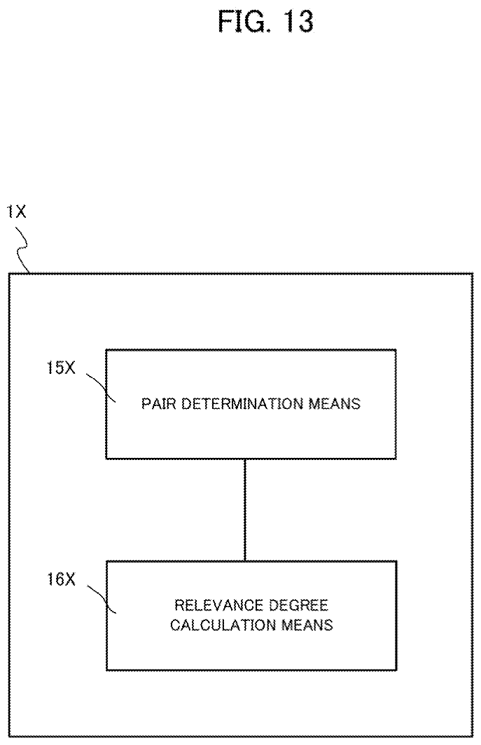

FIG. 13 is a functional block diagram of the information processing device 1X according to the second example embodiment. The information processing device 1X mainly includes a pair determination means 15X and a relevance degree calculation unit 16X.

The pair determination means 15X is configured to determine a pair of data at least one member of which is a first digest candidate that is a candidate of a digest, the data including at least one of video data or audio data. Here, the term “video data” may indicate a single image or may indicate a plurality of images. Examples of the “data” and the “pair” include the “section data” and the “inference target pair Ptag” in the first example embodiment (including modifications, the same is true hereinafter), respectively. Examples of the pair determination means 15X include the pair determination unit 15 and the pair determination unit 15A according to the first example embodiment.

The relevance degree calculation means 16X is configured to calculate a degree of relevance indicating a degree of probability that the pair determined by the pair determination means 15X is included in the digest at a time. Examples of the relevance degree calculation means 16X include the relevance degree calculation unit 16 and the relevance degree calculation unit 16A in the first example embodiment.

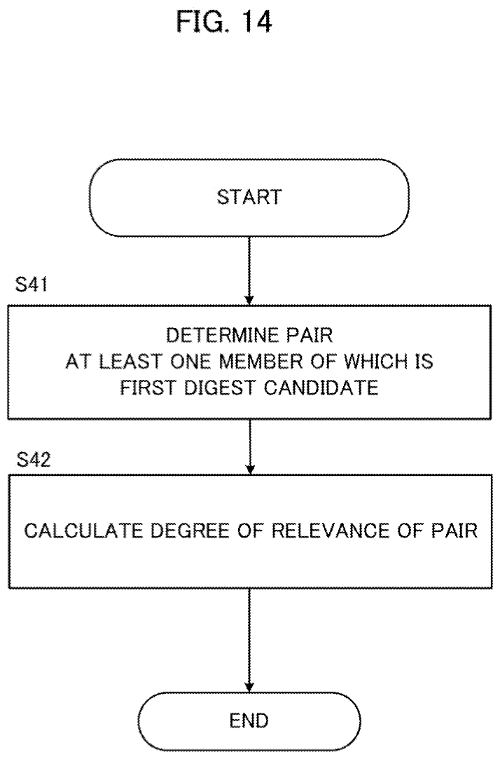

FIG. 14 is an example of a flowchart executed by the information processing device 1X in the second example embodiment. First, the pair determination means 15X determines a pair of data at least one member of which is a first digest candidate that is a candidate of a digest, the data including at least one of video data or audio data (step S41). The relevance degree calculation means 16X calculates a degree of relevance indicating a degree of probability that the pair determined by the pair determination means 15X is included in the digest at a time (step S42).

The information processing device lx according to the second example embodiment can suitably calculate the degree of relevance as an index for determining whether or not two pieces of data should be included in the digest at the same time.

In the example embodiments described above, the program is stored by any type of a non-transitory computer-readable medium (non-transitory computer readable medium) and can be supplied to a control unit or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

The whole or a part of the example embodiments described above (including modifications, the same applies hereinafter) can be described as, but not limited to, the following Supplementary Notes.

### Supplementary Note 1

An information processing device comprising:

a pair determination means configured to determine a pair of data at least one member of which is a first digest candidate that is a candidate of a digest, the data including at least one of video data or audio data; and

a relevance degree calculation means configured to calculate a degree of relevance indicating a degree of probability that the pair is included in the digest at a time.

### Supplementary Note 2

The information processing device according to Supplementary Note 1,

wherein the pair determination means is configured to determine the pair based on section data corresponding to a section of raw material data which serves as material in generation of the digest, the section being identified by dividing the raw material data into a plurality of sections.

### Supplementary Note 3

The information processing device according to Supplementary Note 2, further comprising

a second digest candidate selection means configured to select the section data to be a second digest candidate based on the degree of relevance.

### Supplementary Note 4

The information processing device according to Supplementary Note 3,

wherein the pair determination means is configured to determine the pair of two pieces of the section data corresponding to first digest candidates, and

wherein the second digest candidate selection means is configured to select the first digest candidate to be the second digest candidate based on the degree of relevance.

### Supplementary Note 5

The information processing device according to Supplementary Note 3,

wherein the pair determination means is configured to determine the pair of the first digest candidate and a non-first digest candidate that is the section data not corresponding to the first digest candidate, and

wherein the second digest candidate selection means is configured to select the non-first digest candidate to be the second digest candidate based on the degree of relevance.

### Supplementary Note 6

The information processing device according to any one of Supplementary Notes 2 to 5, further comprising

a first digest candidate selection means configured to select the first digest candidate from the section data based on a degree of importance calculated for each of the section data.

### Supplementary Note 7

The information processing device according to any one of Supplementary Notes 2 to 6,

wherein the pair determination means is configured to determine the pair that is two pieces of the section data between which a difference in playback time is within a predetermined time difference.

### Supplementary Note 8

The information processing device according to any one of Supplementary Notes 2 to 6,

wherein the pair determination means is configured to determine the pair selected from the section data extracted from the raw material data at predetermined time intervals.

### Supplementary Note 9

The information processing device according to any one of Supplementary Notes 2 to 6,

wherein the pair determination means is configured to perform clustering on the section data and determine the pair from the section data belonging to a predetermined class.

### Supplementary Note 10

The information processing device according to any one of Supplementary Notes 1 to 9,

wherein the relevance degree calculation means is configured to calculate the degree of relevance based on a relevance degree inference engine, the relevance degree inference engine being trained by using
a pair of two pieces of section data included in a digest for training generated from raw material data for training as a positive example and
a pair of two pieces of section data other than the pair corresponding to the positive example as a negative example.

### Supplementary Note 11

The information processing device according to any one of Supplementary Notes 1 to 9,

wherein the relevance degree calculation means is configured to calculate the degree of relevance based on a relevance degree inference engine, the relevance degree inference engine being learned to output, when two pieces of data including at least one of video data or audio data is inputted thereto, information on a difference in playback time between the two pieces of data on an assumption that the two pieces of data are extracted from common raw material data.

### Supplementary Note 12

The information processing device according to any one of Supplementary Notes 1 to 11, further comprising

an output control means configured to output information on the degree of relevance or information on a second digest candidate selected based on the degree of relevance.

### Supplementary Note 13

A control method executed by a computer, the control method comprising:

determining a pair of data at least one member of which is a first digest candidate that is a candidate of a digest, the data including at least one of video data or audio data; and

calculating a degree of relevance indicating a degree of probability that the pair is included in the digest at a time.

### Supplementary Note 14

A storage medium storing a program executed by a computer, the program causing the computer to function as:

a pair determination means configured to determine a pair of data at least one member of which is a first digest candidate that is a candidate of a digest, the data including at least one of video data or audio data; and

a relevance degree calculation means configured to calculate a degree of relevance indicating a degree of probability that the pair is included in the digest at a time.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A, 1B, 1X Information processing device

2 Input device

3 Output device

4 Storage device

6 Learning device

8 Terminal device

100, 100B Digest candidate selection system

What is claimed is:

1. An information processing device comprising:
at least one memory configured to store instructions; and
at least one processor configured to execute the instructions to
determine a pair of data at least one member of which is a first digest candidate that is a candidate of a digest, the data including at least one of video data or audio data; and
calculate a degree of relevance indicating a degree of probability that the pair is included in the digest at a time.

2. The information processing device according to claim 1, wherein the at least one processor is configured to execute the instructions to determine the pair based on section data corresponding to a section of raw material data which serves as material in generation of the digest, the section being identified by dividing the raw material data into a plurality of sections.

3. The information processing device according to claim 2, wherein the at least one processor is configured to further execute the instructions to select the section data to be a second digest candidate based on the degree of relevance.

4. The information processing device according to claim 3,
wherein the at least one processor is configured to execute the instructions to determine the pair of two pieces of the section data corresponding to first digest candidates, and
wherein the at least one processor is configured to execute the instructions to select the first digest candidate to be the second digest candidate based on the degree of relevance.

5. The information processing device according to claim 3,
wherein the at least one processor is configured to execute the instructions to determine the pair of the first digest candidate and a non-first digest candidate that is the section data not corresponding to the first digest candidate, and
wherein the at least one processor is configured to execute the instructions to select the non-first digest candidate to be the second digest candidate based on the degree of relevance.

6. The information processing device according to claim 2,
wherein the at least one processor is configured to further execute the instructions to select the first digest candidate from the section data based on a degree of importance calculated for each of the section data.

7. The information processing device according to claim 2,
wherein the at least one processor is configured to execute the instructions to determine the pair that is two pieces of the section data between which a difference in playback time is within a predetermined time difference.

8. The information processing device according to claim 2,
wherein the at least one processor is configured to execute the instructions to determine the pair selected from the section data extracted from the raw material data at predetermined time intervals.

9. The information processing device according to claim 2,
wherein the at least one processor is configured to execute the instructions to perform clustering on the section data and determine the pair from the section data belonging to a predetermined class.

10. The information processing device according to claim 1
wherein the at least one processor is configured to execute the instructions to calculate the degree of relevance based on a relevance degree inference engine, the relevance degree inference engine being trained by using
a pair of two pieces of section data included in a digest for training generated from raw material data for training as a positive example and
a pair of two pieces of section data other than the pair corresponding to the positive example as a negative example.

11. The information processing device according to claim 1
wherein the at least one processor is configured to execute the instructions to calculate the degree of relevance based on a relevance degree inference engine, the relevance degree inference engine being learned to output, when two pieces of data including at least one of video data or audio data is inputted thereto, information on a difference in playback time between the two pieces of data on an assumption that the two pieces of data are extracted from common raw material data.

12. The information processing device according to claim 1
wherein the at least one processor is further configured to execute the instructions to output information on the degree of relevance or information on a second digest candidate selected based on the degree of relevance.

13. A control method executed by a computer, the control method comprising:
determining a pair of data at least one member of which is a first digest candidate that is a candidate of a digest, the data including at least one of video data or audio data; and
calculating a degree of relevance indicating a degree of probability that the pair is included in the digest at a time.

14. A non-transitory computer readable storage medium storing a program executed by a computer, the program causing the computer to:
determine a pair of data at least one member of which is a first digest candidate that is a candidate of a digest, the data including at least one of video data or audio data; and
calculate a degree of relevance indicating a degree of probability that the pair is included in the digest at a time.
